(19) United States
(12) Patent Application Publication
(10) Pub. No.: US 2026/0003647 A1
(43) Pub. Date: Jan. 1, 2026

(54) Monitoring and Visualization of Robotic Process Automations

(71) Applicant: ServiceNow, Inc., Santa Clara, CA (US)

(72) Inventors: Vinay Singh Ram Singh, Hyderabad (IN); Sreekanth Palthya, Hyderabad (IN); Kapu Reddy Vikas, Hyderabad (IN)

(21) Appl. No.: 18/755,988

(22) Filed: Jun. 27, 2024

(51) Int. Cl. G06F 9/451; G06F 9/455

(52) U.S. Cl. CPC G06F 9/451; G06F 9/45558; G06F 2009/45575

(57) ABSTRACT

Example implementations may include capturing virtual bot execution, for example by taking a screen recording of a desktop screen of a virtual machine where the execution is taking place. The contents, such as video such as the recording and/or associated data, may be processed, buffered, stored, and/or transmitted before being streamed (e.g., to a user). Thus, these implementations may involve initiating a virtual bot to execute an operation; generating a graphical representation of the virtual bot executing the operation; and transmitting, to a client device, the graphical representation of the operation for display at the client device.

### BACKGROUND

Robotic process automation (RPA) can be configured to facilitate a virtual bot that carries out various operations for a computing system (e.g., moving files from one location to another, generating analytics, etc.). In some cases, RPA can execute without intervention by a system user or operator. For example, RPA execution may be initiated automatically and/or in the background, such as on a virtual machine or remote desktop. Often, there is limited insight regarding execution of the RPA, such as what steps are involved in the process or how efficiently or effectively the steps are proceeding. Therefore, it may not be possible to determine failure modes or quickly debug issues if RPA execution does not complete as expected. This results in wastage of computing resources (e.g., processing, memory, and/or network capacity) as the RPA may continue executing erroneously and a lengthy trial-and-error process of attempting to debug RPA execution may be required.

### SUMMARY

The absence of visibility into RPA execution limits issue detection and resolution (e.g., if the RPA execution fails). While an RPA may generate logs that represent aspects of its execution, these logs may be difficult to parse, incomplete, and/or may not provide a comprehensive understanding of RPA execution workflows. Accordingly, various implementations disclosed herein include a streaming solution designed to capture, buffer, and stream the execution of RPA. Such streams may provide greater insight into the RPA workflow and allow for more rapid detection, identification, and resolution of issues. The streaming may take place in real-time (or near real-time), or may take place at some time after the execution of the RPA (e.g., minutes, days, or longer).

More specifically, the implementations herein may capture or record RPA execution, for example by taking a screen recording of a desktop screen of a virtual machine where the RPA execution is taking place. The contents (e.g., video such as the recording, and/or associated data) may be processed, buffered, stored, and/or transmitted before being streamed (e.g., to a user aiming to debug an RPA execution failure). In some cases, the streaming may be live. In some cases, users may be able to interact with the stream, for example by starting, stopping, rewinding, sharing, and/or take actions as a result of the stream, for example terminating the RPA execution. In some cases, multiple users may receive streams in parallel or in sequence. This allows rapid debugging of RPA failures, thereby preserving computing resources that otherwise would be wasted with the RPA continuing to execute in the presence of defects.

Accordingly, a first example embodiment may involve initiating a virtual bot to execute an operation; generating a graphical representation of the virtual bot executing the operation; and transmitting, to a client device, the graphical representation of the operation for display at the client device.

A second example embodiment may involve a non-transitory computer-readable medium, having stored thereon program instructions that, upon execution by a computing system, cause the computing system to perform operations in accordance with any of the previous example embodiments.

In a third example embodiment, a computing system may include at least one processor, as well as memory and program instructions. The program instructions may be stored in the memory, and upon execution by the at least one processor, cause the computing system to perform operations in accordance with any of the previous example embodiments.

In a fourth example embodiment, a system may include various means for carrying out each of the operations of any of the previous example embodiments.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6 depicts an architecture for orchestration of RPA, in accordance with example embodiments.

FIG. 7 depicts an architecture for streaming of RPA, in accordance with example embodiments.

FIGS. 8A and 8B depict an example stream of an RPA, in accordance with example embodiments.

FIG. 9 is a flowchart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein. Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### I. EXAMPLE TECHNICAL IMPROVEMENTS

These embodiments provide a technical solution to a technical problem. One technical problem being solved is the lack of visibility into RPA execution. In practice, this is problematic because it limits the ability to promptly detect, diagnose, and resolve issues during RPA execution, as logs can be difficult to parse, incomplete, and may not provide a comprehensive understanding of the RPA workflow. As a result, more computing resources (e.g., processing, memory, and/or network capacity) may be allocated to detecting, identifying, and debugging issues, leading to increased operational costs and reduced efficiency.

In other techniques, issues with RPA execution are often identified and resolved through post-hoc debugging. However, these techniques do not provide visibility into the RPA execution process, and cannot be performed in real-time. Moreover, these other techniques rely on subjective decisions and experiences of individual developers or operators, which leads to wildly varying outcomes from case to case. Thus, other techniques did little, if anything, to address the need for a consistent and efficient method of monitoring and troubleshooting RPA workflow, particularly for real-time detection and/or identification of failure modes.

The embodiments herein overcome these limitations by introducing a streaming solution for capturing and analyzing the execution of RPA workflows. In this manner, monitoring and troubleshooting of RPA processes can be accomplished in a more accurate and robust fashion. This results in several advantages. First, it provides immediate (e.g., real-time or as-needed) visibility into RPA execution, allowing for prompt issue detection and resolution. Second, improved detection and identification of issues during RPA execution may lead to improved root cause analysis of RPA failure modes, and thus enable better development of RPA orchestration architectures and/or RPA deployment, resulting in more robust, efficient, and reliable RPA executions. Third, computing resources are saved by facilitating the early termination of RPA executions that are exhibiting failures or other defects, as well as by streamlining the debugging process.

Other technical improvements may also flow from these embodiments, and other technical problems may be solved. Thus, this statement of technical improvements is not limiting and instead constitutes examples of advantages that can be realized from the embodiments.

### II. INTRODUCTION

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM), IT service management (ITSM), IT operations management (ITOM), and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) has been introduced to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets and/or web components for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist, including but not limited to metadata-based encodings of web components, and various uses of JAVASCRIPT® Object Notation (JSON) and/or extensible Markup Language (XML) to represent various aspects of a GUI.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### III. EXAMPLE COMPUTING DEVICES AND CLOUD-BASED COMPUTING ENVIRONMENTS

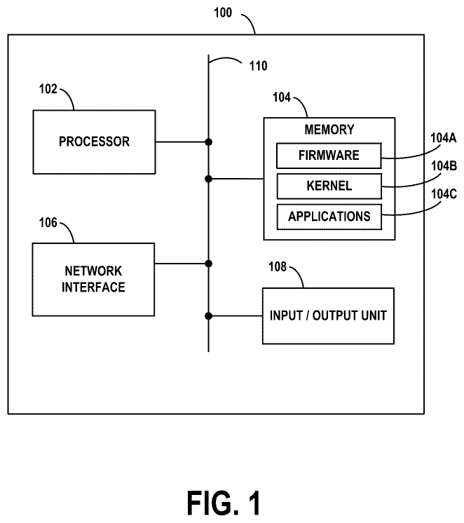

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a graphical processing unit (GPU), another form of co-processor (e.g., a mathematics or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, 10 Gigabit Ethernet, Ethernet over fiber, and so on). Network interface 106 may also support communication over one or more non-Ethernet media, such as coaxial cables or power lines, or over wide-area media, such as Synchronous Optical Networking (SONET), Data Over Cable Service Interface Specification (DOCSIS), or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed. The exact physical location, connectivity, and configuration of these computing devices may be unknown and/or unimportant to client devices. Accordingly, the computing devices may be referred to as “cloud-based” devices that may be housed at various remote data center locations.

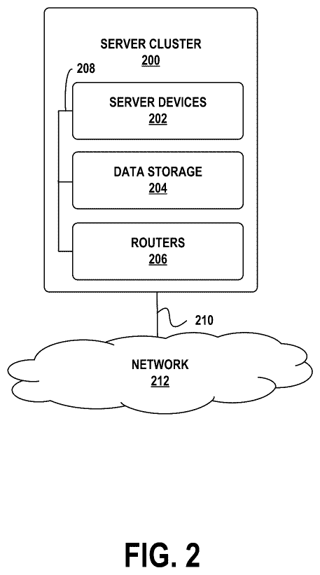

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database or a No-SQL database (e.g., MongoDB). Various types of data structures may store the information in such a database, including but not limited to files, tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, XML, JSON, or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### IV. EXAMPLE REMOTE NETWORK MANAGEMENT ARCHITECTURE

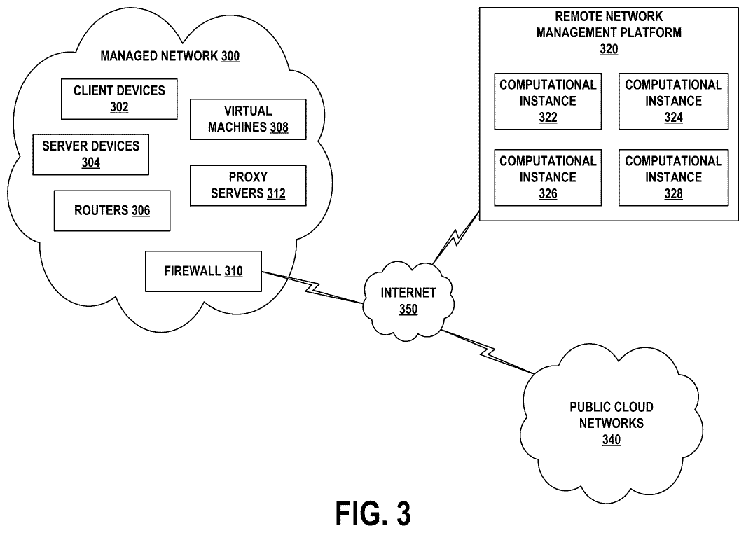

FIG. 3 depicts a remote network management architecture, in accordance with example embodiments. This architecture includes three main components—managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

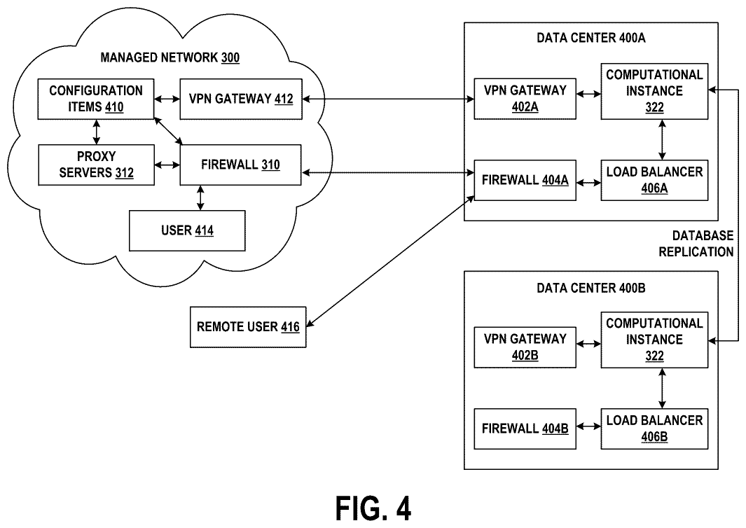

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### V. EXAMPLE DISCOVERY

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of these devices, components, applications, and services may be referred to as configuration items.

The process of determining the configuration items and relationships therebetween within managed network 300 is referred to as discovery, and may be facilitated at least in part by proxy servers 312. To that point, proxy servers 312 may relay discovery requests and responses between managed network 300 and remote network management platform 320.

Configuration items and relationships may be stored in a CMDB and/or other locations. Further, configuration items may be of various classes that define their constituent attributes and that exhibit an inheritance structure not unlike object-oriented software modules. For instance, a configuration item class of “server” may inherit all attributes from a configuration item class of “hardware” and also include further server-specific attributes. Likewise, a configuration item class of “LINUX® server” may inherit all attributes from the configuration item class of “server” and also include further LINUX®-specific attributes. Additionally, configuration items may represent other components, such as services, data center infrastructure, software licenses, units of source code, configuration files, and documents.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

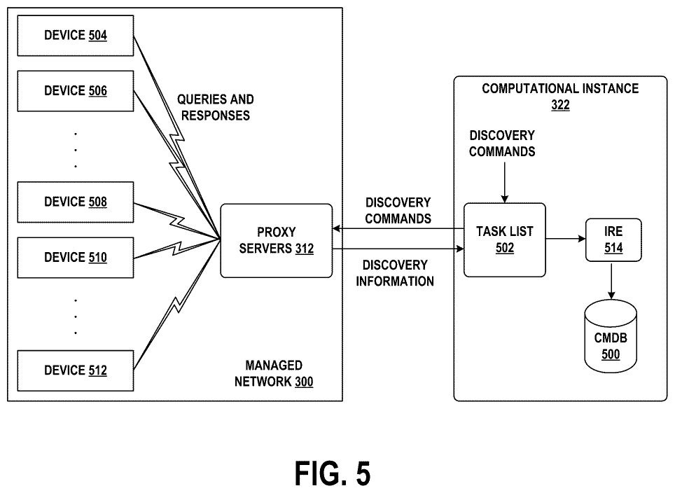

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery-horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases-under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices—for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### VI. CMDB IDENTIFICATION RULES AND RECONCILIATION

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VII. ROBOTIC PROCESS AUTOMATION (RPA)

Robotic process automation (RPA) can be used within computing systems to automate certain routine or repetitive tasks, such as scanning documents for keywords or phrases, sorting data into categories, moving files from one location to another, obtaining information from or writing information to a server or database, generating analytics, and so on. The motivation for RPA is largely in its ability to offload mundane work from various individuals. In this way, these individuals can spend more time on higher-level complex tasks that are more difficult or impossible to automate. In some cases, RPA may involve a degree of artificial cognition (e.g., by employing machine learning models) in order to make predictions or classifications. Thus, enterprises and other organizations can deploy software “bots” (e.g., programs, scripts, etc.) on computing devices to carry out these tasks. In these embodiments, a “bot” may also be referred to as a “virtual bot”, a “robot”, or an “automation”. Other synonymous or similar terms may be used.

Orchestrated RPA can take place on a managed network, such as managed network 300. Architectures for orchestrating RPAs may include capabilities for assigning bots to host computing devices or users, determining how tasks (e.g., in the form of software packages) are assigned to bots, and determining how bots are instructed to execute tasks according to schedules, among other possibilities. Such orchestration may take place on a remote system that, by way of device and software discovery, has a mapping of relationships between hardware devices and software deployed on the managed network. The architecture may add further information relating to bot operation to this framework.

RPA bots may be based on a runtime framework of executable programmatic logic that take the form of any type of software, such as a compiled program, interpreted script, client-server application, and so on. Thus, bots may be referred to as robots, software bots, software programs, or applications, for example. The tasks that bots carry out may be simple, complex, or anywhere in between. Example tasks that are candidates for RPA include data entry, scanning documents for keywords or phrases, sorting data into categories, moving files from one location to another, obtaining information from or writing information to a server or database, generating analytics, troubleshooting, synchronizing data, collecting data from multiple remote sources, and so on. It is possible for bots to perform a wide variety of additional tasks as well across many functions, such as IT, HR, finance, engineering, and/or customer service, just to name a few. The programmatic logic for these tasks may be deployed in packages that are provided to bots for execution.

The automation aspect of RPA may be full, in that a properly configured bot can carry out its activities without human intervention or with a minimal amount of human interaction (e.g., the human may initiate the bot and then the bot performs one or more tasks autonomously). On the other hand, such automation may be partial, in that a bot performs certain subtasks of an overall task while a human performs other subtasks of the overall task.

Regardless of its form, the automation provided by packages may involve rules-based processing, fuzzy logic, machine-learning-based predictions or classification, or other types of algorithms. In some cases, bots may interact with user interfaces, such as parsing prompts and entering data into forms.

Bots can be deployed onto various types of host computing devices. Once deployed, a bot can be assigned tasks to perform on its host. Such tasks can be manually initiated, initiated based on a pre-defined schedule, or initiated based on reception of a trigger (e.g., a request received from a remote device). Deployed bots can be managed in various ways (e.g., stopped, restarted, monitored, modified, etc.). In performing tasks, a bot may communicate with one or more other computing devices that are local or remote to the bot's host computing device (e.g., on the same local network, on the same enterprise network, in a public cloud network, or in a remote network management platform). In some cases, bots may interact with other bots.

Bots may be implemented as fungible units of execution (e.g., one or more operating system processes or threads) that are provided with various rules, scripts, logic, instruction sets, and/or software packages that define tasks. In other words, such a bot may be initiated but idle until it is assigned a task and caused to execute the task. The bot would then execute the task and, upon completion, return its idle state. Then, the bot can be caused to execute the same task again or be assigned a different task.

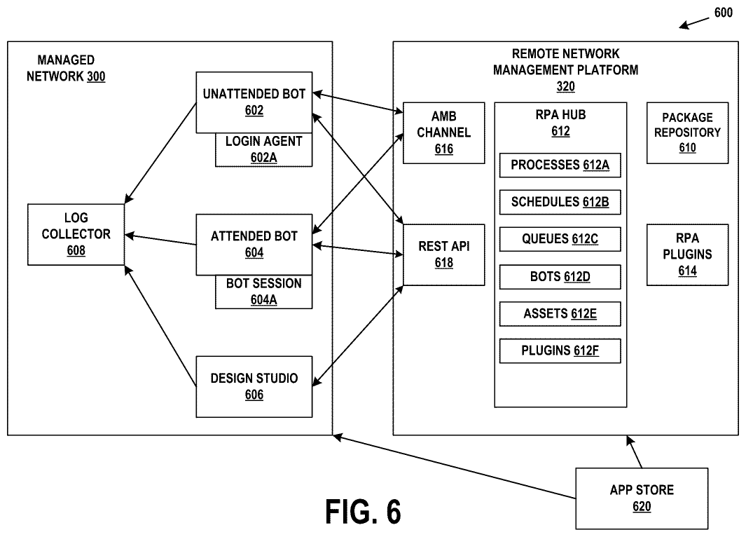

FIG. 6 provides an example architecture 600 for RPA deployment. Architecture 600 includes managed network 300 (which may also be referred to as an enterprise network, a customer network, or a customer environment) and remote network management platform 320.

Managed network 300 may include zero or more instances of each of unattended bot 602, attended bot 604, design studio 606, and log collector 608. More or fewer components related to RPA may be present in managed network 300.

Unattended bot 602 may be a bot that performs autonomous tasks. Accordingly, unattended bot 602 may be installed on a host computing device that is a client device or a server device. Execution of tasks may be based on a pre-determined schedule, triggered by way of an API, or triggered by way of some other type of event. The bots are often installed on virtual machines or execute as background processes. Login agent 602A may be an additional software module that allows unattended bot 602 to log into the host computing device as a particular user or with a particular set of credentials (e.g., a userid/password pair). In this fashion, unattended bot 602 can log in, start a user session, and execute on the host without requiring that a human is logged in. Nonetheless, a human may use the host at the same time as unattended bot 602, and the human might or might not be aware that unattended bot 602 is installed or executing.

Attended bot 604 may be a bot that operates in a partially autonomous fashion, and relies to some extent on human interaction and/or human cognition to carry out its tasks. Accordingly, attended bot 604 is typically installed on a host computing device that is a client device. Bot session 604A may be an additional software module that allows attended bot 604 to log into the host computing device as a particular user or with a particular set of credentials. In this fashion, attended bot 602 can execute on the host alongside the user, but with control of its own input and output (i.e., not relying on a keyboard or mouse for input).

Design studio 606 is a development environment for bots and tasks that are to be performed by bots. Thus, design studio 606 may be deployed mainly on developer machines and does not need to be installed on computing devices that host unattended or attended bots. Design studio 606 may be a low-code/no-code graphical user interface that allows designers to drag and drop representations of instructions and other functionality into software packages that define tasks.

Log collector 608 is a database or other repository that receives and stores event data from unattended bot 602, or attended bot 604, and/or design studio 606. This allows operation of bots to be tracked and debugged as needed. In some cases, log collector 608 may be on the same host computing device that a bot operates, or log collector 608 may be on a separate computing device.

Remote network management platform 320 may include package repository 610, RPA hub 612, RPA plugins 614, AMB channel 616, and/or representational state transfer (REST) API 618. It is generally assumed that these components operate on the same computational instance, but in some cases they could be spread across multiple computational instances.

Package repository 610 may store one or more packages (e.g., units of programmatic logic) that are executable by bots. Thus, each package may take the form of configuration files, rules, scripts, and/or various types of software. Package repository 610 may also include support for versioning of these packages. Packages may be developed by way of design studio 606 and pushed to package repository 610 when they are deemed ready for general use. Packages in package repository 610 may be deployed to host computing devices on managed network 300 by way of AMB channel 616. In some cases, packages may be stored in an external app store 620, and downloaded to package repository 610 on demand or by way of purchase.

RPA plugins 614 may contain building blocks that are used to create a bot. This could include, for example, library functionality that can be reused between bots. Like the packages, some of these plugins may be stored in app store 620 and downloaded to RPA plugins 614 on demand or by way of purchase. Versioning of these plugins may also be available.

RPA hub 612 may contain a set of data structures and/or metadata that coordinate the operation and management of bots. Thus, RPA hub 612 may include records for processes 612A, schedules 612B, queues 612C, bots 612D, assets 612E, and/or plugins 612F.

Processes 612A may contain records that define, for each bot deployed on managed network 300, which package that bot is to execute. Schedules 612B may contain records that define schedules usable by bots. In some embodiments, records in processes 612A may also refer to one or more of these schedules to specify when each bot is to execute its assigned package.

Queues 612C may store entries containing information that is provided from one bot to another bot, or between a bot and another module. This information could be related to tasks carried out by one or more bots, data from a document, data from a database, or other data. For example, a first bot may perform multiple transactions, create work items for these transactions, and push the work items into a queue. A second bot may remove these work items from the queue and perform further steps of the transaction.

Bots 612D may contain records that specify where and/or how bots are deployed on managed network 300. For unattended bots, bots 612D may include a one-to-one mapping between an identifier of the bot and the host computing device on which the bot is installed. For attended bots, bots 612D may include a one-to-one mapping between an identifier of the bot and the user to whom the bot is assigned. Records in bots 612D may be created when a bot is deployed to managed network 300 and may be deleted when a bot is removed from managed network 300.

Assets 612E may contain records of login credentials, environment variables, files, configuration data, or other information used by bots deployed on managed network 300. Plugins 612F may contain records that define, for one or more bots deployed on managed network 300, which of the plugins in RPA plugins 614 that bot relies on (if any).

In some embodiments, processes 612A and bots 612D may take the form of or include references to configuration items stored in a CMDB. These configuration items may then have relationships, also stored in the CMDB, to their host computing devices and bot applications executing on these host computing devices. A benefit of modeling processes 612A and bots 612D as configuration items is that applications (also modeled as configuration items) that are being automated by way of an RPA workflow can be associated to their corresponding processes (e.g., via CMDB relationship mapping). Thus, all affected RPA automations are known if an enhancement and/or change is planned for any of those applications. This results in more effective management of RPA automation as well as avoidance of bot failures.

Asynchronous message bus (AMB) channel 616 facilitates communication between bots deployed on managed network 300 and remote network management platform 320. Thus, a bot may subscribe to one or more sets of records in RPA hub 612 and/or a tables of a CMDB. When any of these records or tables change, an indication of the change may be transmitted to the bot by way of AMB channel 616. For example, if one or more records in processes 612A change, the changes may be pushed to the appropriate bot or bots by way of AMB channel 616. In some cases, AMB channel 616 may take the form of a WebSocket interface.

REST API 618 may be used by bots deployed on managed network 300 as well as design studio 606 to obtain information stored in remote network management platform 320. For example, a bot may use REST API 618 to obtain a record from RPA hub 612 (e.g., credentials, environment variables, work items) or a CMDB (e.g., configuration items).

As an example of how architecture 600 might be used, suppose that a developer associated with managed network 300 uses design studio 606 to develop a package. The developer may upload this package to package repository 610. The package may rely on one or more plugins from RPA plugins 614. Then, entries RPA hub 612 may be added or modified to associate one or more bots with the package, a schedule, assets, and/or, plugins, as well as the host computing devices on which the bots will execute. Then the bots, the package, and/or associated data from RPA hub 612 may be pushed to these host computing devices by way of AMB channel 616. If the bots require further information from remote network management platform 320 prior to or during execution, they can obtain it via REST API 618. Nonetheless, other examples of bot development, deployment, and execution may be possible.

### VIII. STREAMING OF ROBOTIC PROCESS AUTOMATION EXECUTION

Once an RPA architecture is orchestrated, as discussed above (e.g., RPA hub 612 is established for a system), developers may use it to set up various workflows, such as automating data entry or generating reports. The execution of these workflows may occasionally fail, for example, due to changes in underlying systems or unexpected inputs. For instance, consider an RPA workflow designed to automate the login process for a third-party application. The RPA bot could be programmed to navigate to the login screen, input the username and password, and then (assuming login success) proceed with further tasks within the application. However, if the login screen layout or input fields undergo changes, such as the addition of a new field or a rearrangement of existing elements, the RPA bot may fail to locate and interact with the required elements accurately. As a result, the workflow execution would fail, leading to disruptions in automated processes until the RPA bot is updated to adapt to the changes in the login screen layout.

Because RPA processes often occur in the background (e.g., on a virtual desktop that a user cannot access), they may lack visibility for users of a system, making it challenging for the users (e.g., software developers or administrators using the bots) to comprehend how the workflows are executed or debug bot behavior. For instance, if an RPA bot is programmed to automate data extraction from a system's database during downtime periods between other tasks, developers and administrators may have limited visibility into the execution process, hindering their ability to monitor performance, detect inefficiencies, or troubleshoot potential issues in real-time.

Additionally, even in cases where there is no failure (e.g., of the bot), users, such as developers or administrators, may still want to understand how the workflow is executed for optimization or monitoring purposes. For example, consider an RPA workflow responsible for processing data incoming to a system. Even if the workflow successfully processes units of the data without errors, developers and administrators may still want to monitor the RPA execution to ensure that it operates efficiently, detect any potential bottlenecks or inefficiencies in the process, and identify opportunities for improvement to enhance overall system performance and throughput.

Accordingly, it may be beneficial to provide more visibility and/or observability into an RPA workflow. Specifically, disclosed herein are implementations for streaming RPA execution, including real-time streaming and/or buffered streaming. These techniques may facilitate issue detection and enable efficient debugging, as well as improve future RPA development efforts.

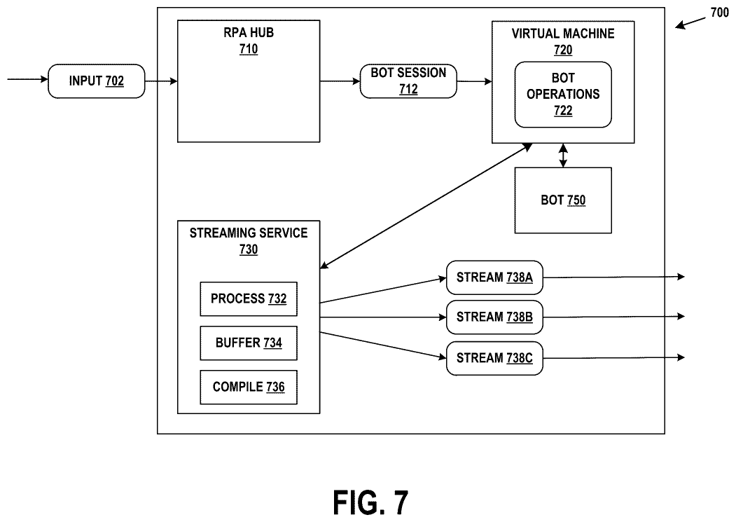

FIG. 7 illustrates an example streaming architecture 700 for streaming an RPA execution (e.g., a bot completing a programmed task, such as logging in to a system and sending out a document from a template). For the purposes of this disclosure, a “bot” may refer to an RPA execution, and such a bot may be configured to execute the tasks associated with an RPA workflow, as discussed above.

RPA hub 710 may be an implementation of RPA hub 612, as discussed in the context of FIG. 6 above. RPA hub 710 may have additional or different features, and other embodiments are possible. RPA hub 710 may be configured to receive an input 702. Input 702 may be a user command entered through a graphical user interface (GUI), where an administrator manually starts a bot and enables streaming by selecting options from a control panel. Alternatively, input 702 may be an automated trigger from a scheduling system, which initiates the bot process and streaming at predefined times or intervals. Input 702 may also be a script executed by the RPA hub, which includes specific parameters for the bot operation and streaming configuration. Additionally, input 702 may be a signal from another integrated software application (such as a workflow management system or an event monitoring tool), indicating the need for RPA monitoring based on certain criteria, such as high transaction volumes, detected anomalies, or scheduled maintenance windows.

Input 702 may indicate that a bot process should start and/or that the bot process should include a streaming capability, and may provide specifics about the streaming, such as initializing a screen recording session, setting up a real-time video buffer, and establishing an HTTP server for live streaming the captured data.

RPA hub 710 may be configured to process input 702 to establish a bot's (such as bot 750) execution environment, including generating an RPA execution and/or receiving information about an existing RPA execution. For example, RPA hub 710 may initiate bot session 712. In some embodiments, bot session 712 may already be initiated, and RPA hub 710 may obtain information about bot session 712. RPA hub 710 may be configured to check that bot session 712 is in session and/or that components for streaming are initialized. This may include verifying network connectivity, allocating sufficient memory and processing power for video encoding, and/or setting up secure communication channels for transmitting a stream. Such configurations may be customized based on user preferences or organizational policies.

Virtual machine 720 may be configured to receive bot session 712 and/or host the execution of bot session 712. Virtual machine 720 may form part of a managed network, such as managed network 300 in the context of FIG. 3 and/or FIG. 6. Virtual machine 720 may refer to any system or platform where bot 750 is executing an RPA workflow. For example, virtual machine 720 may be a virtual environment that within an organization's data center, and/or cloud-based, and/or provided by third-party service providers.

Bot operations 722 may include operations executed during bot session 712 (i.e., operations performed by bot 750 during RPA execution). For example, bot operations 722 may include tasks such as interacting with user interfaces, extracting and processing data, automating repetitive workflows, and integrating with various software applications. For instance, bot operations 722 may involve logging into applications, filling out forms, copying data between systems, generating reports, sending emails, and handling exceptions.

For example, in a data processing workflow, bot operations 722 might include retrieving information from a database, entering the information into another system, generating a report, and emailing the report to a user. In another scenario, bot 750 might be tasked with monitoring network traffic levels and alerting multiple users if it exceeds pre-determined levels. Bot operations 722 may take place across various environments and applications within the managed network. In some examples, bot operations may include interacting with other networks or systems, such as third-party applications or servers within the managed network.

Streaming service 730 may be configured to interact with virtual machine 720. This interaction may include receiving or obtaining information (e.g., data representing bot operations 722, such as pixels) and/or initiating a recording session (e.g., commencing a screen recording on virtual machine 720).

Additional examples of information that streaming service 730 may receive from virtual machine 720 include system metrics (e.g., CPU usage, memory consumption, disk I/O, and network activity), logs of actions performed by bot 750, including timestamps and status messages, error messages and stack traces (e.g., generated by bot 750 or virtual machine 720), states of applications being automated, such as open windows, active processes, and application-specific logs, and/or metadata such as highlighted areas, mouse movements, and click events on virtual machine 720, among other possibilities.

Streaming service 730 may initiate and/or obtain a recording or representation of bot operations 722 through on-demand recording, automated triggers, conditional recording, API calls, workflow integration, and/or user-defined rules, among other possibilities. On-demand recording may allow a user to manually start and stop recording sessions through a control panel or dashboard. For example, an administrator might click a “Start Recording” button in RPA hub 710 to begin capturing bot operations 722. As another example, a recording can be automatically initiated based on specific triggers or events, such as the start of a bot session, detection of an error, or a scheduled time. For instance, the system might automatically begin recording when a high-priority bot begins its task. As another example, a recording may start when certain conditions are met, such as when bot 750 interacts with certain applications or performs high-risk operations. For example, the system might trigger screen recording when bot 750 accesses data or executes a particular, pre-defined transaction. In some cases, external systems can initiate recording by making API calls to the streaming service. For example, a monitoring system could send a request to start recording if it detects abnormal behavior in performance metrics.

Streaming service 730 may be configured to perform operations of blocks process 732, buffer 734, and compile 736. These operations may take place in parallel and/or in series. Process 732 operations may include processing data from virtual machine 720, for example into discrete blocks or segments for efficient processing. For example, streaming service 730 may partition a video stream into smaller chunks based on time intervals or file size to facilitate parallel processing and reduce latency. Buffer 734 operations may include temporarily storing data in a buffer or cache before it is transmitted or processed further (e.g., in chronological order). In the context of streaming, buffering helps smooth out playback by storing a portion of the video stream in advance, allowing fewer interruptions during playback (e.g., if there are fluctuations in network bandwidth or latency). Compile 736 operations may include aggregating and organizing the data into a cohesive format for presentation or analysis. For instance, streaming service 730 may compile individual video segments, metadata, and other supplementary information into a unified video file or stream format that can be easily accessed and viewed.

Streaming service 730 may additionally or alternatively be configured to perform operations such as encrypting data to improve secure transmission and reduce unauthorized access or interception, decrypting data, compressing data, processing or handling playback controls (such as play, pause, rewind, fast forward, and seek) to allow users to navigate through the streamed content, quality adjusting a streaming quality (e.g., based on available network bandwidth and device capabilities), error handling, access control, metadata injection, among other possibilities.

Streaming service 730 may be configured to output one or more streams, for example stream 738A, stream 738B, and/or stream 738C (“the streams”). These streams may transmit information to one or more client devices for display (e.g., by establishing network connections between the streaming service and client devices). Each stream represents a separate data feed containing the information about bot operations 722 (e.g., a screen capture).

Information from streaming service 730 can be transmitted through various communication protocols and technologies, including HTTP Live Streaming (HLS), real-time messaging protocol (RTMP), or other forms of image, video, and/or text transmission. For example, HLS can deliver audio and video content over the internet in small chunks. Streaming service 730 may segment a stream into short segments and serve them to client devices via HTTP. Client devices may request and download these segments, playing them back in sequence to display the stream (e.g., on a user interface).

Streaming service 730 may be configured to transmit the streams automatically and/or based on receiving an indication to begin streaming. In some cases, a client device may request access to a stream, and streaming service 730 may send a corresponding stream of data to the client device over the network. This transmission may occur in real-time or near real-time, enabling users to view bot operations 722 as they happen.

In some cases, the streams may be a live stream and/or the streams may be a delayed stream. A live stream includes cases where information (e.g., a video feed) is transmitted in real-time, meaning that viewers can watch a bot's activities (e.g., bot operations 722) as they are happening. A delayed stream refers to a transmission with a delay introduced between the time the content is captured and when it is presented to users. This delay may vary in length, ranging from a few seconds to several minutes to weeks, or even longer.

In some embodiments, multiple client devices can simultaneously receive and display streams from streaming service 730, enabling distributed monitoring and collaboration among users. This may allow developers, administrators, and other stakeholders to observe and analyze the bot's execution from different locations and devices, facilitating efficient troubleshooting and oversight of RPA workflows.

In some cases, RPA hub 710 and/or streaming service 730 may be configured to enable or commence a stream at various points during RPA execution (e.g., at initiation of the bot, according to default settings, automatically, and/or only if a bot fails to execute).

As discussed above, issues and/or failures of a bot to execute may occur at various stages, such as configuration errors, compatibility issues with third-party interfaces, or discrepancies in the input data. For instance, the bot may encounter difficulties navigating a newly updated user interface of a third-party application, leading to unexpected behavior or errors in its execution. Similarly, configuration errors in the bot's parameters or dependencies could result in suboptimal performance or failure to complete tasks as intended. Additionally, inconsistencies or inaccuracies in the input data provided to the bot could lead to erroneous outcomes or failures in data processing tasks.

As such, in some cases, based on the streams, users or systems may be able to interfere with bot execution and/or take remedial measures. For example, users monitoring the live stream of a bot's activities may notice an unexpected error or deviation from the expected workflow. RPA hub 710 and/or streaming service 730 may be configured to include controls that allow a user to pause or stop a bot, modifying its parameters, or provide manual input to correct the issue and ensure the successful completion of the task. Similarly, automated systems may analyze the streams to detect anomalies or patterns indicative of errors, and/or trigger automated responses such as alert notifications to administrators or automatic adjustments to the bot's behavior to mitigate potential risks or failures.

In some cases, the operations discussed above may be augmented and/or replaced with information from logs associated with bot operations 722 (such as those contained in log collector 608, as discussed in the context of FIG. 6). For example, logs may be used to obtain timestamps or indications of when a bot failed in executing an operation, which could be cross-referenced with a recording of the bot's execution to better-determine a failure mode.

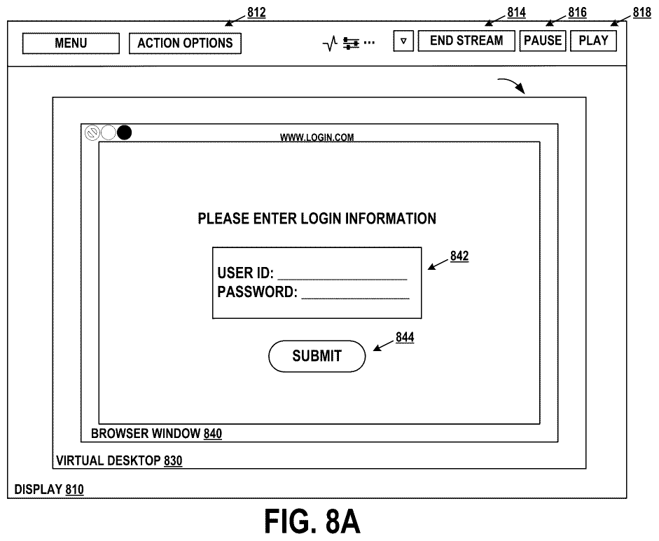

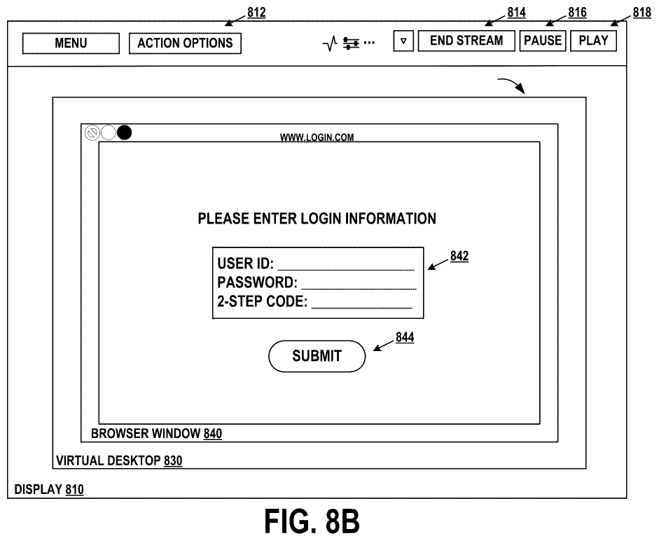

As a concrete example use of streaming architecture 700, FIG. 8A and FIG. 8B depict display 810, which may be a display viewable by a user of a system (e.g., a display on a computer of a system administrator). Display 810 may include virtual desktop 830, which may be a view or screen representing a device or system where an RPA workflow is executing (e.g., a virtual machine, such as virtual machine 720 as discussed in the context of FIG. 7). Virtual desktop 830 may include browser window 840, which may be a browser window involved in the RPA workflow. Browser window 840 may include input area 842 and submit button 844. Display 810 may also include various controls, such as action options 812, end stream 814, pause 816, and play 818.

In the context of FIGS. 8A and 8B, consider an RPA workflow where a bot is programmed to log in to a third-party website (represented by browser window 840) and enter various credentials into input area 842. Such operations may be part of a larger RPA workflow (e.g., to send out a document, fill out a form, or place pre-determined text into a text box). In FIG. 8A, input area 842 includes a user ID field and a password field. In FIG. 8B, input area 842 additionally includes a 2-step code (e.g., an authentication code). If the bot is not configured to obtain and input a 2-step code, the RPA execution may fail to complete. Accordingly, a user of the system may want to view a stream of the bot's operations to better determine why the RPA execution is failing to complete (in this case, because of the 2-step code requirement).

Putting this example in the context of FIG. 7, a user could provide input 702 to RPA hub 710 to indicate that a stream should commence for this RPA execution (bot session 712). Virtual machine 720 may be configured to host virtual desktop 830. Bot operations 722 may include the bot inputting information into input area 842 and clicking submit button 844. Streaming service 730 may perform operations such as process 732, buffer 743, and compile 736 to generate display 810 (e.g., stream 732A). As discussed above, the user may be able to rectify or modify the RPA workflow (e.g., through action options 812). For example, the user could provide the bot with a 2-step code or end the RPA execution. Additionally, the user may be able to interact with the stream (e.g., by terminating, pausing or playing the stream via end stream 814, pause 816, and play 818).

### IX. EXAMPLE OPERATIONS

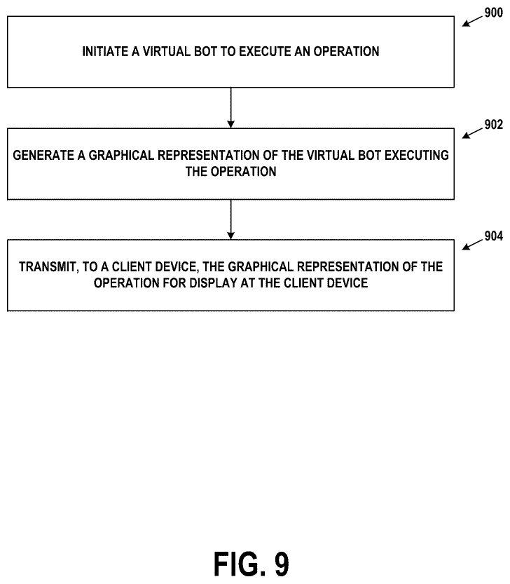

FIG. 9 is a flow chart illustrating an example embodiment. The process illustrated by FIG. 9 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 9 may be simplified by the removal of any one or more of the features shown therein. Further, these embodiments may be combined with features, aspects, and/or implementations of any of the previous figures or otherwise described herein.

Block 900 may involve initiating a virtual bot to execute an operation. Block 902 may involve generating a graphical representation of the virtual bot executing the operation. Block 904 may involve transmitting, to a client device, the graphical representation of the operation for display at the client device. Such a graphical representation allows remote observation and debugging of how the virtual bot executes the operation. Doing so reduces the amount of time a virtual bot will executed incorrectly and saves computing resources that would otherwise be used for the incorrect execution and/or a lengthier debugging session.

In some implementations, receiving a request for streaming related to execution of the virtual bot, wherein generating the graphical representation of the virtual bot executing the operation is in response to receiving the request.

In some implementations, the virtual bot includes software deployed on a computing system that is configured to perform one or more operations on the computing system including the operation.

In some implementations, the computing system is a virtual machine that performs screen captures to obtain the graphical representation of the virtual bot executing the operation.

In some implementations, generating the graphical representation of the virtual bot executing the operation comprises generating the graphical representation while the virtual bot executes the operation.

In some implementations, generating the graphical representation of the virtual bot executing the operation comprises storing the graphical representation in memory.

In some implementations, transmitting the graphical representation of the operation for display at the client device comprises retrieving the graphical representation from the memory.

In some implementations, the memory comprises a volatile memory configured to store a buffer of graphical representations, wherein the transmitting the graphical representation of the operation for display at the client device comprises streaming the graphical representations to the client device.

In some implementations, streaming the graphical representations to the client device occurs in real time as the virtual bot is executing the operation.

In some implementations, streaming the graphical representations to the client device is responsive to commands receivable from the client device for starting, stopping, rewinding, or sharing the streaming.

In some implementations, streaming the graphical representations to the client device comprises: receiving the graphical representations from a computing system on which the virtual bot executes the operation, wherein the graphical representations are frames of a video segment; storing, in a buffer, the frames in chronological order; and transmitting, to the client device, a first frame of the frames while a second frame of the frames remains stored in the buffer awaiting transmission, wherein the first frame was captured before the second frame was captured.

In some implementations, initiating the virtual bot to execute the operation is in response to receiving a command from the client device.

In some implementations, the client device is configured to provide a command that terminates execution of the virtual bot.

In some implementations, the operation comprises the virtual bot entering pre-determined data into a representation of a graphical user interface.

In some implementations, the graphical user interface comprises a text box and the pre-determined data comprises text to be placed in the text box.

### X. CLOSING

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of non-transitory computer readable medium such as a storage device including RAM, ROM, a disk drive, a solid-state drive, or another tangible storage medium.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
initiating a virtual bot to execute an operation;
generating a graphical representation of the virtual bot executing the operation; and
transmitting, to a client device, the graphical representation of the operation for display at the client device.

2. The method of claim 1, further comprising:
receiving a request for streaming related to execution of the virtual bot, wherein generating the graphical representation of the virtual bot executing the operation is in response to receiving the request.

3. The method of claim 1, wherein the virtual bot includes software deployed on a computing system that is configured to perform one or more operations on the computing system including the operation.

4. The method of claim 3, wherein the computing system is a virtual machine that performs screen captures to obtain the graphical representation of the virtual bot executing the operation.

5. The method of claim 1, wherein generating the graphical representation of the virtual bot executing the operation comprises generating the graphical representation while the virtual bot executes the operation.

6. The method of claim 1, wherein generating the graphical representation of the virtual bot executing the operation comprises storing the graphical representation in memory.

7. The method of claim 6, wherein transmitting the graphical representation of the operation for display at the client device comprises retrieving the graphical representation from the memory.

8. The method of claim 7, wherein the memory comprises a volatile memory configured to store a buffer of graphical representations, and wherein the transmitting the graphical representation of the operation for display at the client device comprises streaming the graphical representations to the client device.

9. The method of claim 8, wherein streaming the graphical representations to the client device occurs in real time as the virtual bot is executing the operation.

10. The method of claim 8, wherein streaming the graphical representations to the client device is responsive to commands receivable from the client device for starting, stopping, rewinding, or sharing the streaming.

11. The method of claim 1, wherein streaming the graphical representations to the client device comprises:
receiving the graphical representations from a computing system on which the virtual bot executes the operation, wherein the graphical representations are frames of a video segment;
storing, in a buffer, the frames in chronological order; and
transmitting, to the client device, a first frame of the frames while a second frame of the frames remains stored in the buffer awaiting transmission, wherein the first frame was captured before the second frame was captured.

12. The method of claim 1, wherein initiating the virtual bot to execute the operation is in response to receiving a command from the client device.

13. The method of claim 1, wherein the client device is configured to provide a command that terminates execution of the virtual bot.

14. The method of claim 1, wherein the operation comprises the virtual bot entering pre-determined data into a representation of a graphical user interface.

15. The method of claim 14, wherein the graphical user interface comprises a text box and the pre-determined data comprises text to be placed in the text box.

16. A non-transitory computer-readable medium, having stored thereon program instructions that, upon execution by a computing system, cause the computing system to perform operations comprising:
initiating a virtual bot to execute an operation;
generating a graphical representation of the virtual bot executing the operation; and
transmitting, to a client device, the graphical representation of the operation for display at the client device.

17. The non-transitory computer-readable medium of claim 16, wherein generating the graphical representation of the virtual bot executing the operation comprises storing the graphical representation in memory, and wherein transmitting the graphical representation of the operation for display at the client device comprises retrieving the graphical representation from the memory.

18. The non-transitory computer-readable medium of claim 17, wherein the memory comprises a volatile memory configured to store a buffer of graphical representations, and wherein the transmitting the graphical representation of the operation for display at the client device comprises streaming the graphical representations to the client device.

19. The non-transitory computer-readable medium of claim 18, wherein streaming the graphical representations to the client device occurs in real time as the virtual bot is executing the operation.

20. A system comprising:
one or more processors; and
memory, containing program instructions that, upon execution by the one or more processors, cause the system to perform steps comprising:
initiating a virtual bot to execute an operation;
generating a graphical representation of the virtual bot executing the operation; and
transmitting, to a client device, the graphical representation of the operation for display at the client device.
